(19) United States
(12) Patent Application Publication
(10) Pub. No.: US 2003/0213340 A1
(43) Pub. Date: Nov. 20, 2003

(54) Reverse torque drive ratchet wrench

(76) Inventor: Ray M. Alden, Raleigh, NC (US)

Correspondence Address: Ray M. Alden, 808 Lake Brandon Trail, Raleigh, NC, 27610, US

(21) Appl. No.: 10/147,783

(22) Filed: May 16, 2002

(51) Int. Cl. B25B 17/00

(52) U.S. Cl. 81/57.29

(57) ABSTRACT

The invention described herein relates to hand powered tools which drive nuts, bolts, screws, and the like. The invention is a ratchet wrench wherein in a first setting a means to receive counterclockwise hand force and convert it into clockwise rotational driving force is provided. Said first setting also comprising a means to receive clockwise hand force and produce clockwise rotational driving force. Likewise, said ratchet wrench, when in a second setting, producing counterclockwise rotational driving force when clockwise hand force is applied and producing counterclockwise rotational driving force when counterclockwise hand force is applied. The result being that the ratchet drives the work twice as efficiently as prior art ratchet wrenches that rely on driving and slipping cycles when being cranked. By contrast, the present invention relies on cycles with two driving components each with opposite slipping cycles such that no net slipping occurs.

### BACKGROUND FIELD OF INVENTION

The field of hand cranked ratchets and wrenches is crowded with art describing drive methodologies, switching mechanisms, and design improvements drawn to making sturdy, reliable, and easily operated hand wrenches and ratchets. Specifically well known are ratchets and wrenches that convert hand force to rotational torque applied to work such as nuts and bolts. Such ratchets being a means to turn the work in a first rotational direction when force is applied to the tool in said first direction and then providing a means to slip so as not to turn the work when force is applied in a second (opposite) direction. Ratchets commonly are switchable such that in a first setting they can turn work in a clockwise direction and slip in a counterclockwise direction and in a second setting, they can turn work in a counterclockwise direction and slip in a clockwise direction. The slipping process enables the user to reset the tool's position without disengaging the socket from the work.

The present invention provides a reverse torque means to a rotating hand tool such as a wrench or ratchet. When the reverse torque means of the present invention is used in conjunction with the forward torque of the prior art, a 100% more efficient hand tool results. In a first setting, this novel tool provides a clockwise torque when clockwise force is applied and a clockwise torque when counterclockwise force is applied. (The cranking motion that the prior art used to slip the tool into position in the is now used to perform work in the present invention.) Likewise, in a second setting, this novel tool provides a counterclockwise torque when clockwise force is applied and a counterclockwise torque when counterclockwise force is applied.

### BACKGROUND DESCRIPTION OF PRIOR INVENTION

The prior art describes many constructs of hand tools designed to provide a torque in a first rotational direction and a slip in second rotational direction. The slipping process being a means to reposition the tool without turning the work in an undesired direction while also keeping the tool engaged with the work. Wei, U.S. Pat. No. 6,101,902; Olson, U.S. Pat. No. 3,962,925; Wright et al, U.S. Pat. No. 4,147,076; Main, U.S. Pat. No. 4,807,500; and Colvin, U.S. Pat. No., 4,485,700 each representing prior art examples of hand tools providing a slipping means.

The present invention replaces the slipping mode of the prior art with a reverse torque mode. The tool provides the ability to rotate the work in a desirable rotational direction regardless of whether the hand force is applied in the same rotational direction or in the opposite rotational direction. By replacing the prior art's non-productive (slipping) half of the wrench cycle with a performing half, the present tool is 100% more efficient than the prior art.

### BRIEF SUMMARY

The invention described herein represents a significant advancement in hand tools. It provides a means to rotate an object such as a nut in a first direction by applying force in that same first direction. The tool also provides a means to rotate an object in said first direction by applying a force in a second (opposite) direction. The tool being switchable to similarly provide rotation in a second (opposite) direction.

In a first, ratchet embodiment, the present tool is configured with a drive, similarly to prior art ratchets, to accept sockets.

In a second, wrench embodiment, the present tool is configured similarly to prior art wrenches with a socket size integrated therein.

Objects and Advantages

Accordingly, several objects and advantages of the present invention are apparent. It is an object of the present invention to provide a reverse torque means in a hand tool such as a ratchet wrench. It is an object of the present invention to provide a reverse torque means with a forward torque means combined in one hand tool. It is an object of the present invention to enable a user to use both the forward hand motion to rotate the work in a first rotational direction and the reverse hand motion to rotate the work in the same first rotational direction. It is an advantage of the present invention to stack two driving means within one tool, each of said means engaging in opposite directions and slipping in opposite directions such that the desired rotational direction is output regardless of what direction the tool is rotated. It is an advantage of the present invention that 100% greater motion efficiency is achieved over prior art. It is an advantage of the present invention that the forward torque produced by the wrench when a reverse force quantity is applied is equal to the torque produced when a forward force quantity (opposite in magnitude) is applied. It is an advantage of the present invention that all of the prior art functionality is incorporated therein.

Further objects and advantages will become apparent from the enclosed figures and specifications.

### DRAWING FIGURES

FIG. 1 is a cutaway view of reverse torque drive mechanism housed in a ratchet wrench.

FIG. 2 illustrates the ratchet wrench body means for receiving rotational force from a hand.

FIG. 3a illustrates the rotational directions of the reverse torque components.

FIG. 3b shows the reverse torque elements not cutaway.

FIG. 4a shows the reverse drive mechanism stacked with a forward drive mechanism.

FIG. 4b describes the reverse drive gear interface with the forward drive gear.

FIG. 5 is an enlarged cutaway of the reversing drive elements.

FIG. 6a describes a view of an alternate driving architecture.

FIG. 6b is a cutaway side view of the alternate driving architecture of FIG. 6a.

FIG. 6c are the torque reversing elements of FIG. 6b.

FIG. 7 is a close-up of some rotational reversing elements of FIG. 6b.

FIG. 8 depicts a wrench embodiment of the present invention.

### NUMERALS IN FIGS.

21 ratchet housing

23 first converting gear

23a alternate first converting gear

23b second embodiment first converting gear

25 first engaging teeth

27 interior teeth

29 second converting gear

29a alternate second converting gear

31 secondary axis of rotation

31a alternate secondary axis of rotation

31b second embodiment secondary axis of rotation

33 drive axis of rotation

33a alternate drive axis of rotation

35 gear mount

35a alternate gear mount

35b second embodiment gear mount

37 reverse drive gear

37a alternate reverse drive gear

37b second embodiment reverse drive gear

39 reversing pawl

39a alternate reversing pawl

41 pawl lever

41a alternate pawl lever

43 pawl rivet

45 pawl notch

47 pawl bearing

49 bearing spring

51 wrench handle

53 bearing seat

55 bearing assembly

55a alternate bearing assembly

57 first pawl motivator seat

59 second pawl motivator seat

61 hole for pawls

63 spring seat

65 gear nipple

65a alternate gear nipple

67 pawl rotation axis

69 forward drive gear

69a alternate forward drive gear

71 forward drive pawl

71a alternate forward drive pawl

73 first pawl motivator

73a alternate first pawl motivator

75 pawl motivator axel

75a alternate pawl motivator axel

77 pawl motivator teeth

77a alternate pawl motivator teeth

79 socket drive

79a alternate socket drive

81 reverse gear flange

83 second pawl motivator

85 reverse gear receiver

87 drive assembly stamp seal

91 reverse drive and forward drive means

91a alternate reverse drive and forward drive means

101 wrench

103 bearing ring assembly

105 reversing gear assembly axel

107 rotating axel

109 compression washer

113 bearing assembly

### DETAILED DESCRIPTION OF THE INVENTION

First Embodiment—Ratchet

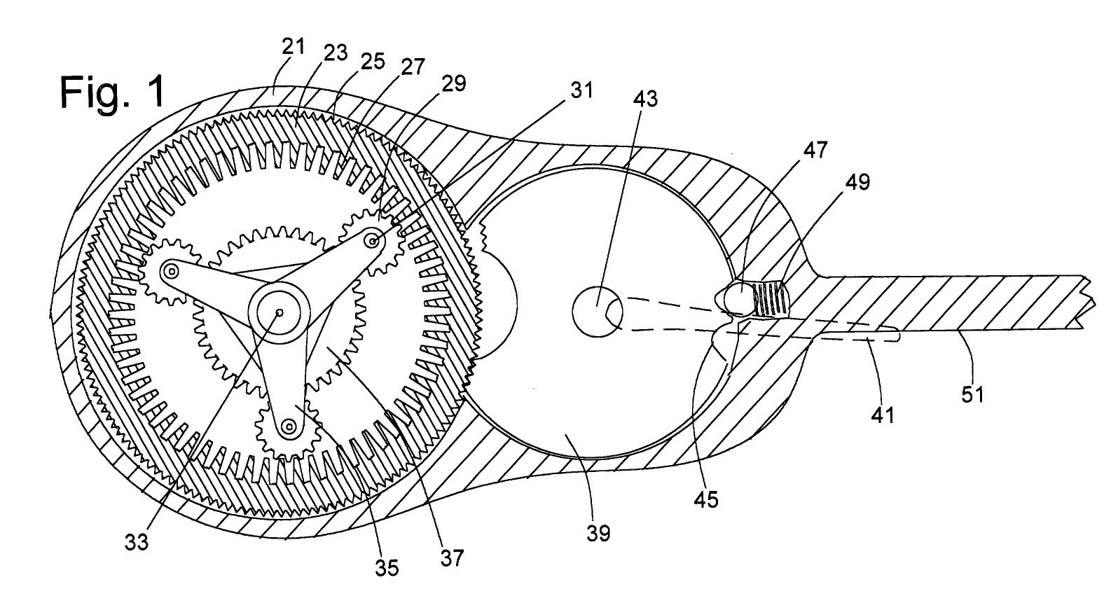

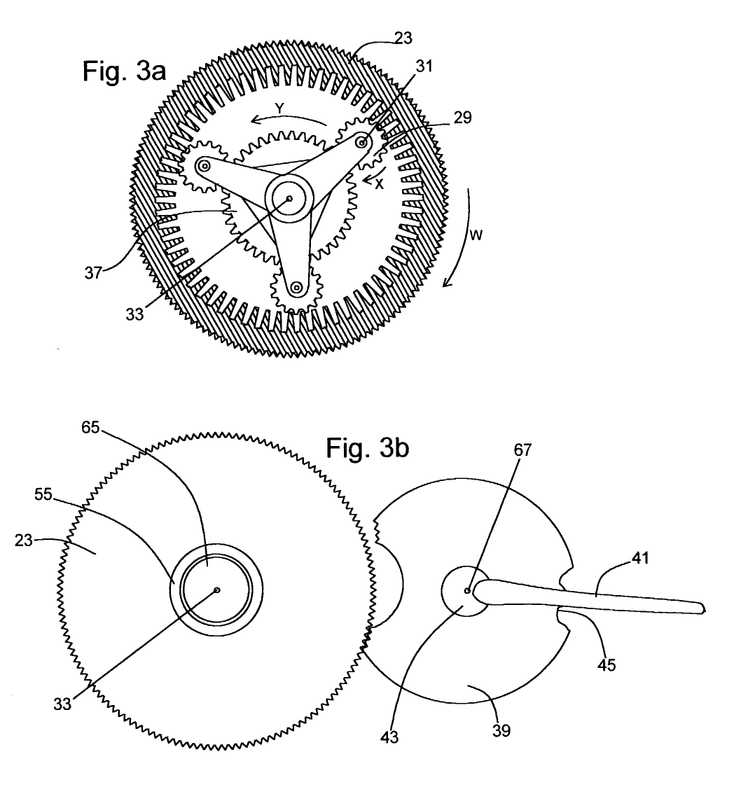

FIG. 1 is a cutaway view of reverse torque drive mechanism housed in a ratchet wrench. All of the components within this Figure are constructed by well known means of steel. Either being casted, machined, stamped or otherwise produced by one skilled in the art of steel component manufacture. Said reverse torque drive mechanism designed to receive hand force in a first rotational direction from a wrench handle 51 and reverse its rotational direction to produce a substantially opposite rotational driving force. The 51 rotates a ratchet housing 21 which houses reversing mechanisms and switching means as follows. A pawl lever 41 is used to select the tool's setting by being actuated by a user and thereby rotating a reversing pawl 39 to seat in one of two settings. A pawl rivet 43 connects the 39 to the 21, while enabling the 39 to rotate. A pawl bearing 47 maintains the selected position of the 39 by being pushed into a hole similar to a pawl notch 45 by a bearing spring 49. Thus one set of teeth on the 39 engage with a first engaging teeth 25 on a first converting gear 23 while the other set of teeth on 39 do not engage the teeth of 23. With the 39 thus engaged with the 23, a clockwise rotational force applied by a hand to 51, causes the 21 and 23 to rotate in a clockwise rotational direction along a drive axis of rotation 33 Meanwhile, the work (a nut, not shown) provides resistance through components later discussed, also along the 33. Resistance from the work prevents the elements within the 23 from rotating freely. A 27 interior teeth conveys the rotational hand force in a clockwise fashion to a 29 second converting gear which causes the 29 to rotate in a clockwise direction. The 29 conveys force from the 23 to a reverse drive gear 37 which rotates the a counterclockwise rotation around the 33. As later discussed, the rotational force within 37 is transferred down the 33 to rotate the work (or nut not shown). The 29 rotating around a 31 secondary axis of rotation and being rotatably connected to a gear mount 35. The 35 rotates around the 33. The rotations are further illustrated in FIG. 3a. Thus clockwise rotational force applied by a hand is converted by a means to produce counterclockwise rotational force on work such as a nut. When the 39 is in its current setting and counterclockwise force is applied to 51, the 39 will slip over the teeth of 23 Oust like ratchets of the prior art except in reverse). Thus the 39 produces a reverse drive and slip cycle opposite to the pawls in the prior art. (However, by also using a second pawl as later discussed, the work will rotate counterclockwise whether the 51 is moved clockwise or counterclockwise.

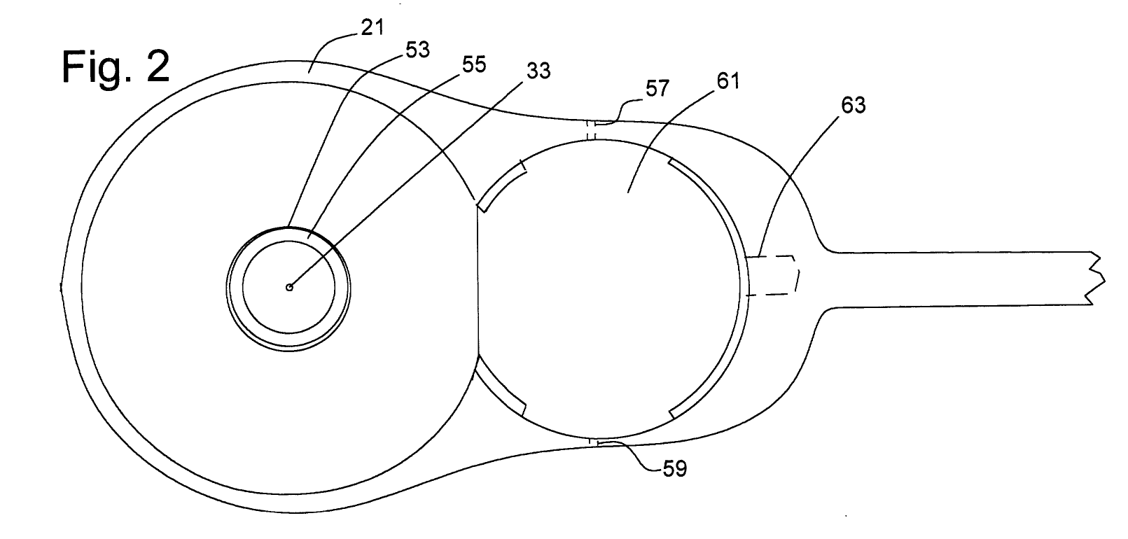

FIG. 2 illustrates the ratchet wrench body means for receiving rotational force from a hand. A bearing seat 53 is notched into the 21 so as to accept a bearing assembly 55. The 55 accepts the to of 23 so as to enable it to rotate along the 33 as later discussed. A first pawl motivator seat 57 is a hole in the 21 to be discussed later as is a second pawl motivator seat 59. The 39 resides in a hole for pawls 61. Likewise the 49 and 47 reside in a spring seat 63.

FIG. 3a illustrates the rotational directions of the reverse torque components. As force is applied to the 23 in a clockwise or “W” direction, it causes the 29 to rotate in a or “X” direction. This rotational energy is converted to a counterclockwise rotational direction “Y” in 37. It should be noted that force applied at 51 and resistance presented by the work, will cause 29 to “walk”. This is because the 29 and other gears connected to the 35 together with the 35, can as a unit, freely rotate around the 33. The circumference ratio of 23, 29, and 37 together with the walking of 29 produce a 1 to −1 hand rotation to drive rotation relationship which is the opposite of the 1 to 1 hand rotation to drive rotation of the prior art. A relationship of 23=10 units, 29=2.5 units, and 37=5 units produces a sufficient reverse torque to perform work.

FIG. 3b shows the reverse torque elements not cutaway. The 23 is constructed so as to have a top including a protruding gear nipple 65 so that the gear 23 can ride efficiently within the 55. Also, the 39 when be actuated to select a setting, rotates about a pawl rotation axis 67.

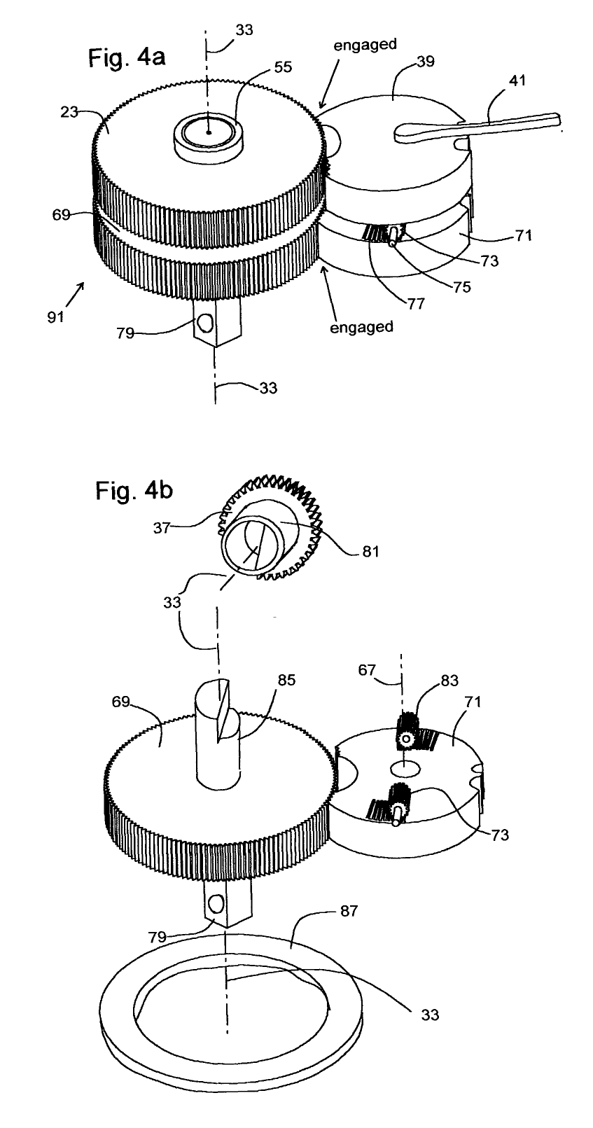

FIG. 4a shows the reverse drive mechanism stacked with a forward drive mechanism. A reverse drive and forward drive means 91 comprises a rotational reversing means as described herein together with a forward rotational means as described in the prior art. Combining the two drive means in one tool enables the 39 to rotate a socket drive 79 in a clockwise direction (using counterclockwise hand force and while slipping when clockwise hand force is applied). While in the same setting, a forward drive pawl 71 rotates the 79 in a clockwise direction, (using clockwise hand force and while slipping when counterclockwise hand force is applied). When the user actuates the 41 such the 39 teeth are engaged on side of the 39, the 71 rotates in the opposite direction such that teeth on its opposite side engage with a forward drive gear 69. This reverse rotation is caused by a first pawl motivator 73 which is in a fixed position relative to the 21 due to its pawl motivator axel 75 being mounted within the 59. Teeth on the underside of 39 and the upper side of 71 similar to pawl motivator teeth 77 ensure that the rotational energy from 39 is efficiently transferred to 71 via 73.

FIG. 4b describes the reverse drive gear interface with the forward drive gear. A reverse gear flange 81 has a flat side within it. 81 fits over reverse gear receiver 85 to transfer its reverse rotational energy to 79 and thereby into the work such as a nut. Note that a second pawl motivator 83 is also seen, it performs similarly to the 73. During assembly, a drive assembly stamp seal 87 is compressed in to 21 to contain the forward and reverse drive components within the 21.

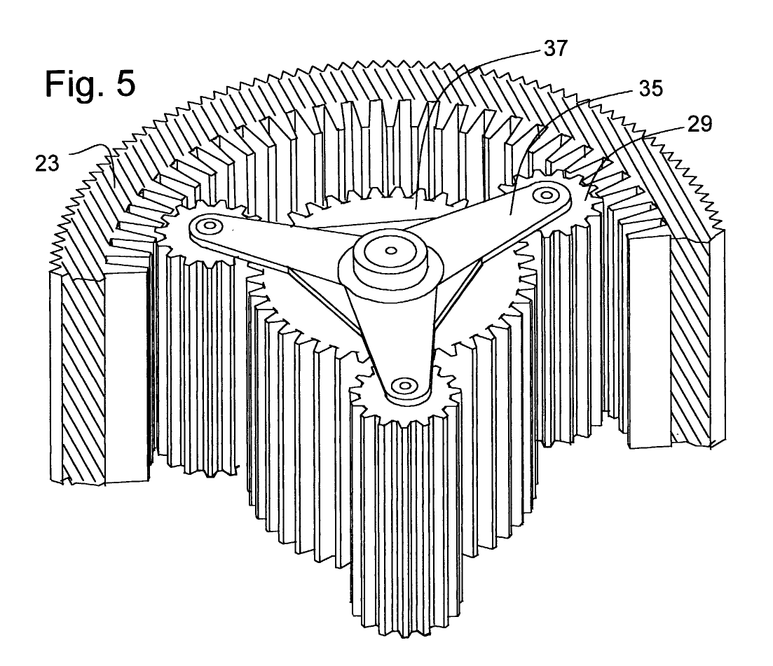

FIG. 5 is an enlarged cutaway of the reversing drive elements. 23, 37, 29 all being cylindrical members.

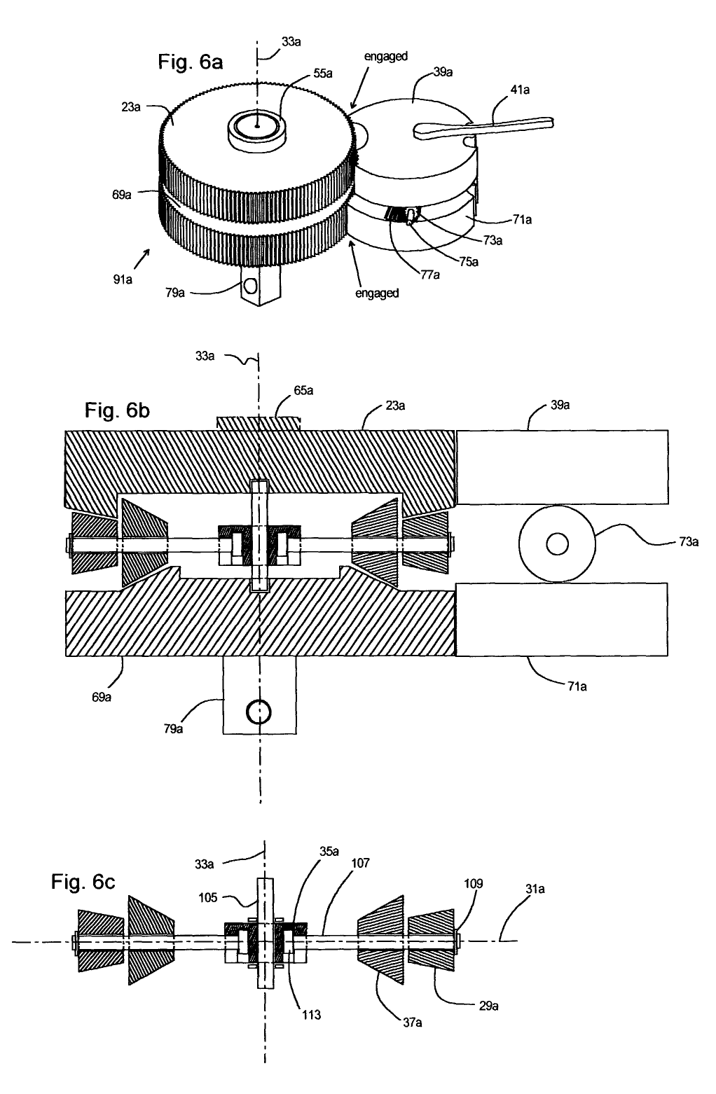

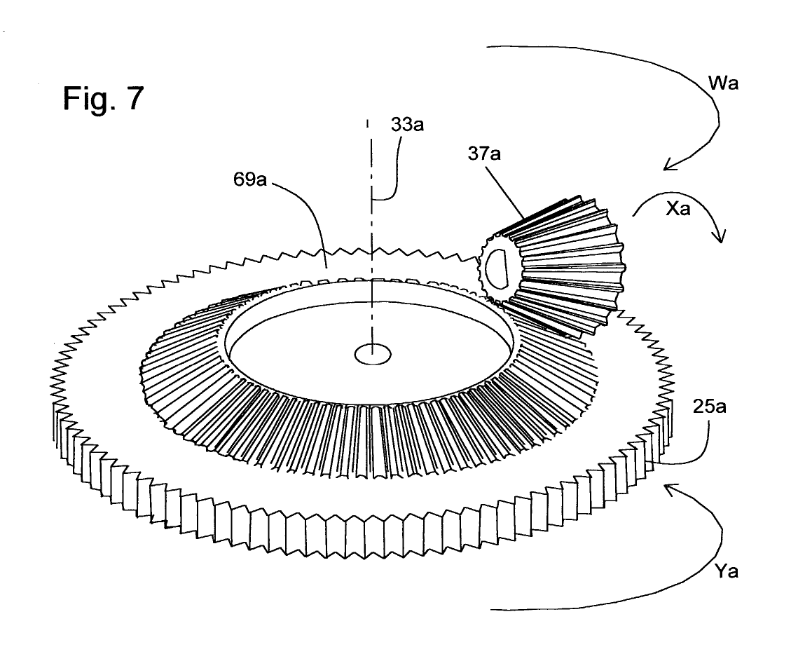

FIG. 6a describes a view of an alternate driving architecture. A alternate first converting gear 23a contains elements described in FIGS. 6b, 6c, and 7. It too comprises a means to receive rotational force from a hand in a first rotational direction and to convert it into reverse rotational in a second (substantial opposite) rotational direction. The 23a and other drive elements rotate around a alternate drive axis of rotation 33a. An alternate bearing assembly 55a is provided to enable the 23a to rotate with the 53 of the 21. An alternate reversing pawl 39a, an alternate pawl lever 41a, an alternate forward drive pawl 71a, an alternate first pawl motivator 73a, an alternate pawl motivator axel 75a, an alternate pawl motivator teeth 77a, an alternate socket drive 79a, and an alternate reverse drive and forward drive means 91a each being constructed and operated as previously discussed. An alternate forward drive gear 69a being altered to accept revered rotational force differently as described in FIGS. 6b and 6c.

FIG. 6b is a cutaway side view of the alternate driving architecture of FIG. 6a. The cutaway view shows the reversing elements in FIGS. 6a, 6b, 6c and 7 are positioned significantly different that those preceding but operating similarly. A alternate gear nipple 65a rides within the 55a to keep it rotatably on the 33a axis.

FIG. 6c are the torque reversing elements of FIG. 6b. When counterclockwise force is applied to 51, transferred through 39a into 23a, it is received by an alternate second converting gear 29a. Through intermeshing teeth (not shown) on the bottom of 23a. The 29a being fastened onto a rotating axel 107 by a compression washer 109. As 29a rotation causes the 107 to likewise rotate. An alternate reverse drive gear 37a is caused to also likewise rotate by also being fastened to the 107. The 107 freely rotating around an alternate secondary axis of rotation 31a held in place by a bearing assembly 113 which fits snugly into an alternate gear mount 35a. counterclockwise rotational energy is converted from 23a to 29a to 107 to 37a, into 69a and into 79a to be clockwise rotation applied to the work such as a nut through a socket (not shown) which affixes to 79a in a well known manner. Teeth on the surfaces of 23a, 29a, 37a, and on the top of 69a are not shown here but are exemplified in FIG. 7. During this process the 71a pawl's teeth slip across the teeth of 69a. Then, when in the return stroke, the user's hand applies clockwise force to the 51, the 39a's teeth slip across the 23a but the 71a teeth engage producing a clockwise rotation of the work (such as a nut). Thus the first pawl produces desired work rotation when a force is applied is an opposite rotational direction while the second pawl slips and on the return stroke, the first pawl slips while the second pawl produces desired work rotation. The ratchet wrench producing desired work rotation on both the forward and reverse strokes. The circumference relationships of 29a, 37a, 23a, and 69a being selected so as to produce a torque on −1. The 35a and attachments rotating around a reversing gear assembly axel 105 which is rotatably seated within 23a on one end and 69a on the opposite end.

FIG. 7 is a close-up of some rotational reversing elements of FIG. 6b. When the 23a is caused to rotate in a clockwise manner such as “Wa”, 37a is caused (through 29a and 107) to rotate in a counter clockwise manner “Xa” (depending upon perspective), this causes the 69a to rotate in a counter clockwise manner “Yaw” at a speed (and torque) suitable for driving work through the 79a. The 29a and 23a having teeth and meshing similarly with those described in FIG. 7. The 37a and the 29a having a flat side within their shaft holes so as to rotate with 107. The 107 having a matching flat side up to a point such that 37a can not move beyond that point.

Second Embodiment—Wrench

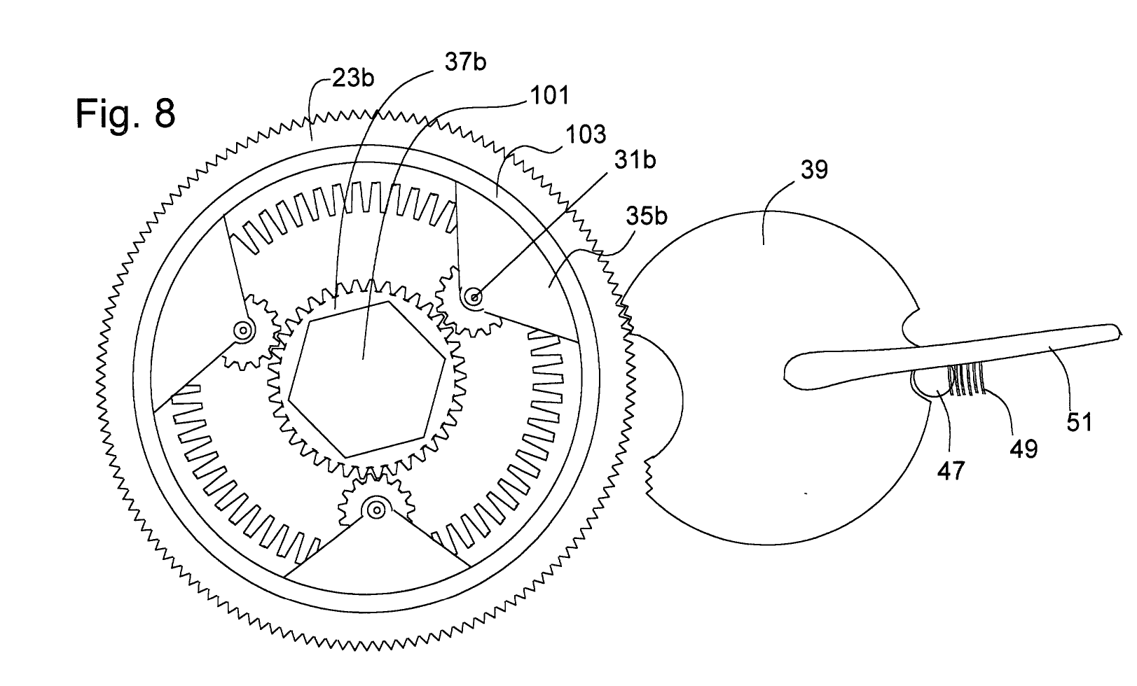

FIG. 8 depicts a wrench embodiment of the present invention. The elements of FIG. 8 providing a means to accept rotational energy, convert it to a reverse rotational direction and into work such as a nut (not shown). A second embodiment reverse drive gear 37b has a wrench size incorporated therein as a wrench 101 to accept a specific nut size. A 39 engages with a second embodiment first converting gear 23b to rotate 23b in a counterclockwise direction. 23b transfers the rotation as previously discussed into 37b via gears riding within a second embodiment gear mount 35b which rotates with a bearing ring assembly 103.

Operation of the Invention

The preceding section also describes detailed operation of the invention.

Conclusion, Ramifications, and Scope

Thus the reader will see that the Reverse Torque Drive Ratchet Wrench of this invention provides a highly functional and reliable means for turning a nut in a desired rotational direction while applying force to the wrench handle in the opposite direction

While the above description describes many specifications, these should not be construed as limitations on the scope of the invention, but rather as an exemplification of two preferred embodiments thereof Many other variations are possible.

Gears, chains, belts and other methods are well known for converting a first rotational direction into a second directional rotation. Many combinations thereof being possible to provide a means to rotate in a reverse direction. Converting gears can be used to change the applied force to resultant torque ratio. Additionally, the circumference relationships of 29, 37, and 23 could be many other ratios than presented herein, as could the circumference relationships of 23a, 29a, 69a, and 37a. Furthermore, 37a and 29a can be combined into one unit. Many means of engaging and disengaging drivers are well known in the prior art. Other applications of the art disclosed herein are also possible.

What is claimed:

1. A hand tool comprising a means for receiving force from a hand in a first rotational direction, wherein a means is provided for converting said force into a second rotational direction substantially opposite to said first rotational direction.

2. The hand tool of claim 1 wherein force from said second rotational direction is used to drive a nut.

3. The hand tool of claim 1 wherein said means for receiving force from a hand receives force in said second rotational direction, wherein work is performed in substantially the same said second rotational direction.

4. The hand tool of claim 1 wherein said means for converting force into a substantially opposite rotational direction comprises a cylindrical rotating member.

5. The invention of claim 4 wherein said cylindrical rotating member comprises a gear.

6. A hand tool with a rotating work driving means wherein,
a means is provided to receive clockwise rotational energy from a hand wherein,
a means is provided for converting said clockwise rotational energy into counterclockwise rotation of said rotating work driving means.

7. The hand tool of claim 6 wherein said work driving means turns a nut.

8. The hand tool of claim 6 wherein a means is provided to receive counterclockwise rotational energy from a hand wherein, said counterclockwise rotational energy results in counterclockwise rotation of said rotating work driving means.

9. The hand tool of claim 6 wherein said means for converting said clockwise rotational energy comprises a cylindrical rotating member.

10. The hand tool of claim 9 wherein said cylindrical rotating member comprises a gear.
